(19) United States
(12) Patent Application Publication
(10) Pub. No.: US 2025/0103084 A1
(43) Pub. Date: Mar. 27, 2025

(54) PRESSURE COMPENSATING BUTTON

(71) Applicant: Apple Inc., Cupertino, CA (US)

(72) Inventors: William C. Lukens, San Francisco, CA (US); Michael R. Parker, Loomis, CA (US)

(21) Appl. No.: 18/820,901

(22) Filed: Aug. 30, 2024

Related U.S. Application Data
(60) Provisional application No. 63/584,325, filed on Sep. 21, 2023.

(51) Int. Cl. G05G 5/00; G05G 25/04; H01H 13/18; H01H 13/52

(52) U.S. Cl. CPC G05G 5/005; G05G 25/04; H01H 13/186; H01H 13/52; G05G 2700/02; H01H 2221/064; H01H 2227/034

(57) ABSTRACT

A pressure compensating button can include a depressible interface. The depressible interface can define an external surface of the electronic device. The button can include a tactile switch. The button can include a first pressure accumulator, such as a first piston or plunger. The first pressure accumulator can be associated with the depressible interface. The first pressure accumulator can be configured to receive a first hydrostatic pressure. The button can include a second pressure accumulator, such as a second piston or plunger. The second pressure accumulator can be configured to receive a second hydrostatic pressure. The second pressure accumulator can counteract the first pressure accumulator, such as via a mechanical linkage, to limit an actuation of the tactile switch via the first hydrostatic pressure. Additional systems and methods are also disclosed.

### CROSS-REFERENCE TO RELATED APPLICATION(S)

This application claims the benefit of U.S. Provisional Patent Application No. 63/584,325, filed 21 Sep. 2023, and entitled “PRESSURE COMPENSATING BUTTON,” the entire disclosure of which is hereby incorporated by reference.

### FIELD

The described embodiments relate generally to electronic devices. More particularly, the present embodiments relate to pressure compensating buttons.

### BACKGROUND

Sealed electronic device buttons can include pistons and seals for sealing out water or other fluids and allow a button force to be transferred onto a tactile switch. When underwater, however, the hydrostatic pressure on the pistons can, at certain depths and pressures, provide enough force on the button to trigger the tactile switch, rendering the button unusable. To counteract this, some electronic devices can detect submersion and disable use of the button. However, disabling buttons reduces the functionality of the electronic devices while submersed.

Therefore, a need exists in the art for pressure compensating button that addresses the above deficiencies or at least offers an alternative to current systems and devices.

### SUMMARY

Various examples of the present disclosure include an electronic device. The electronic device can include a housing and a button assembly. The housing can define an internal volume. The button assembly can include a depressible interface. The depressible interface can define an external surface of the electronic device. The button assembly can include a tactile switch. The button assembly can include a first pressure accumulator. The first pressure accumulator can be associated with the depressible interface. The first pressure accumulator can be configured to receive a first hydrostatic pressure. The button assembly can include a second pressure accumulator. The second pressure accumulator can be coupled to the first pressure accumulator. The second pressure accumulator can be configured to receive a second hydrostatic pressure.

In one example, the button assembly can include a mechanical linkage coupling the second pressure accumulator to the first pressure accumulator. The second pressure accumulator can reduce a force applied by the first pressure accumulator on the tactile switch. In one example, the button assembly can include a lever disposed in the internal volume. The first pressure accumulator can include a first piston extending from the depressible interface and through the housing into the internal volume to contact the lever at a first contact point. The second pressure accumulator can include a second piston extending through the housing into the internal volume to contact the lever at a second contact point. The button assembly can include a fulcrum disposed between the first contact point and the second contact point, the lever pivotable about the fulcrum. In one example, the tactile switch can be configured to contact the lever between the fulcrum and the second contact point. In one example, the electronic device can include a first seal disposed between the first piston and the housing. The electronic device can include a second seal disposed between the second piston and the housing. In one example, the first contact point can be at a first distance from the fulcrum. The second contact point can be at a second distance from the fulcrum. The first distance can be less than the second distance. In one example, the first piston can exert a first force on the lever. The second piston can exert a second force on the lever. The tactile switch can exert a third force on the lever. The depressible interface can exert a fourth force on the lever. In one example, the first piston can include a first diameter. The second piston can include a second diameter. The second diameter can be sized relative to the first diameter such that the third force is zero when the fourth force is zero.

Various examples of the present disclosure include a button assembly. The button assembly can include a depressible interface exposed to an external environment. The button assembly can include a lever isolated from the external environment, the lever including a fulcrum. The button assembly can include a first piston having a first size. The first piston can be exposed to the external environment. The first piston can extend from the depressible interface to exert a first force on the lever at a first contact point. The button assembly can include a second piston having a second size. The second piston can be exposed to the external environment. The second piston can be configured to exert a second force on the lever at a second contact point. The second force can be configured to reduce the first force. The button assembly can include a tactile switch.

In one example, the fulcrum can be disposed between the first contact point and the second contact point. In one example, the tactile switch can be disposed between the fulcrum and the second contact point. In one example, the tactile switch can be configured to exert a third force on the lever. The depressible interface can be configured to exert a fourth force on the lever. The second piston can be sized relative to the first piston such that the third force is zero when the fourth force is zero. In one example, the first piston can be cylindrical. The first size can include a first diameter of the first piston. The second piston can be cylindrical. The second size can include a second diameter of the second piston. The second diameter can be sized relative to the first diameter such that when the fourth force is zero, the third force is zero. In one example, the first piston can be movable through a first water tight seal isolating the external environment from an internal environment. The second piston can be movable through a second water tight seal isolating the external environment from the internal environment. In one example, the tactile switch can be isolated from the external environment via the first water tight seal and the second water tight seal.

Various examples of the present disclosure include a pressure compensation system for an electronic device. The pressure compensation system can include a housing. The housing can define an internal volume. The housing can define a piston aperture. The housing can define a reference aperture. The pressure compensation system can include a button assembly. The button assembly can include a piston extending through the piston aperture into the internal volume. The pressure compensation system can include a differential pressure sensor. The differential pressure sensor can be configured to measure a first pressure within the internal volume. The differential pressure sensor can be configured to measure a second pressure of the reference aperture.

In one example, the pressure compensation system can include a seal disposed between the piston and the housing. The internal volume can be isolated from an external environment and can be defined between the seal and the differential pressure sensor. In one example, the pressure compensation system can include a gel disposed in the reference aperture. In one example, the piston can be exposed to the external environment. In one example, the button assembly can include a depressible interface. The depressible interface can be exposed to the external environment and can define an external surface of the electronic device. The piston can extend from the depressible interface. The piston can be movable through the piston aperture to change a size of the internal volume. In one example, the piston can have a diameter equal to the diameter of the reference aperture.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows an example of a wearable electronic device;

FIG. 1B shows a top view of a portion of the wearable electronic device;

FIG. 1C shows a bottom view of a portion of the wearable electronic device;

FIG. 2 shows a schematic view of a pressure compensating button; and

FIG. 3 shows a schematic view of another pressure compensating button.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to a pressure compensating button for an electronic device. The pressure compensating button can include various configurations and arrangements to limit undesired actuation of a switch due to hydrostatic pressure. For example, the pressure compensating button can limit actuation caused by hydrostatic pressure while diving or swimming at depth below the water's surface. As a result, the pressure compensating button can be used while at depth.

The pressure compensating buttons disclosed herein can compensate (e.g., automatically, passively, etc.) for hydrostatic pressure, such that normal functionality and tactile feedback are maintained while at depth. In some examples, mechanical linkages or systems can be used to compensate for the force from hydrostatic pressure. For instance, a pressure compensating button can include a second, reference piston to counteract or offset hydrostatic forces applied to a button piston.

In some examples, a pressure compensating button can use one or more sensors, sensor systems, or sensor arrangements to compensate for hydrostatic pressure. For instance, a button piston can be attached with a sealed volume to a pressure sensor (e.g., a differential pressure sensor). A differential sensor can then be used to compensate for hydrostatic pressure by exposing the differential sensor to the external environment, such as via a gel or an additional sealed piston. In such examples, the differential sensor can be activated when the pressure in the sealed volume exceeds the reference pressure of the external environment (+/−a threshold).

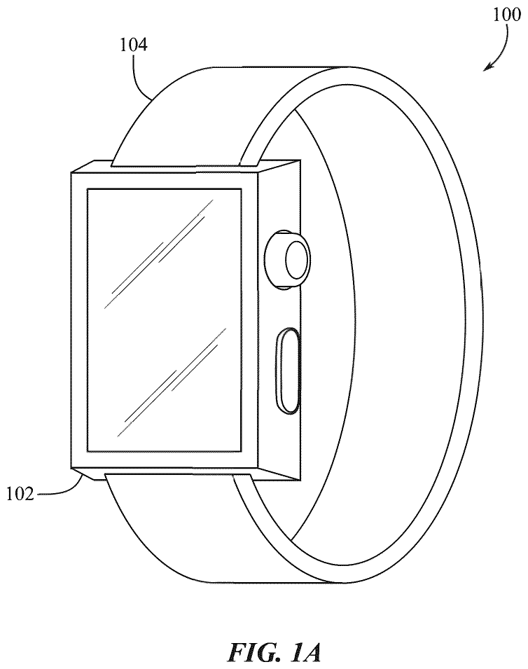

These and other examples are discussed below with reference to FIGS. 1-3. However, those skilled in the art will readily appreciate that the detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1A shows an example of an electronic device 100. The electronic device 100 shown in FIG. 1A is a watch, such as a smartwatch. The smartwatch of FIG. 1A is merely one representative example of a device that can be used in conjunction with the systems and methods disclosed herein. Electronic device 100 can correspond to any form of wearable electronic device, a portable media player, a media storage device, a portable digital assistant (“PDA”), a tablet computer, a computer, a mobile communication device, a GPS unit, a remote control device, or other electronic device. The electronic device 100 can be referred to as an electronic device, or a consumer device. In some examples, the electronic device 100 can include a housing 102 that can carry operational components, for example, in an internal volume at least partially defined by the housing. The electronic device 100 can also include a strap 104, or other retaining component that can secured the device 100 to a body of a user as desired. Further details of the electronic device are provided below with reference to FIG. 1B.

FIG. 1B illustrates the electronic device 100, for example a smartwatch, that can be substantially similar to, and can include some or all of, the features of the devices described herein, including the electronic device 100 shown in FIG. 1A but without the strap 104. The device 100 can include a housing 102, and a display assembly 106 attached to the housing 102. The housing 102 can substantially define at least a portion of an exterior surface of the device 100.

The display assembly 106 can include a glass, a plastic, or any other substantially transparent exterior layer, material, component, or assembly. The display assembly 106 can include multiple layers, with each layer providing a unique function, as described herein. Accordingly, the display assembly 106 can be, or can be a part of, an interface component. The display assembly 106 can define a front exterior surface of the device 100 and, as described herein, this exterior surface can be considered an interface surface. In some examples, the interface surface defined by display assembly 106 can receive inputs, such as touch inputs, from a user.

In some examples, the housing 102 can be a substantially continuous or unitary component and can define one or more openings to receive components of the electronic device 100. In some examples, the electronic device 100 can include input components such as one or more buttons 108 and/or a crown 110 that can be disposed in the openings. In some examples, a material can be disposed between the buttons 108 and/or crown 110 and the housing 102 to provide an airtight and/or watertight seal at the locations of the openings. The housing 102 can also define one or more openings or apertures, such as aperture 112 that can allow for sound to pass into or out of the internal volume defined by the housing 102. For example, the aperture 112 can be in communication with a microphone component disposed in the internal volume. In some examples, one or multiple apertures 112 can be in communication with a speaker component disposed in the internal volume. In some examples, the housing 102 can define or include a feature, such as an indentation, to removably couple the housing 102 and a strap or retaining component.

FIG. 1C shows a bottom perspective view of the electronic device 100. The device 100 can include a back cover 114 that can be attached to the housing 102, for example, opposite the display assembly 106. The back cover 114 can include ceramic, plastic, metal, or combinations thereof. In some examples, the back cover 114 can include an at least partially electromagnetically transparent component 116. The electromagnetically transparent component 116 can be transparent to any desired wavelengths of electromagnetic radiation, such as visible light, infrared light, radio waves, or combinations thereof. In some examples, the electromagnetically transparent component 116 can allow sensors and/or emitters disposed in the housing 102 to communicate with the external environment. Together, the housing 102, display assembly 106 and back cover 114 can substantially define an internal volume and an external surface of the device 100.

In some examples, the electronic device 100 can include one or more sensors 120. The electronic device 100 shown in FIG. 1C includes multiple sensors 120. However, the embodiment illustrated in FIG. 1C is merely one representative example, and the electronic device 100 can include any number of sensors 120, including a single sensor 120 or more than two sensors 120. The sensors 120 can be configured to detect a surrounding environmental characteristic. For example, one or more sensors 120 can detect a barometric pressure, an altitude, the presence of water or fluid, or an underwater depth, among other characteristics. In such examples, the one or more sensors 120 can include a depth sensor, an altimeter, a pressure sensor, or the like.

Any of the features, components, and/or parts, including the arrangements and configurations thereof shown in FIGS. 1A-1C can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 1A-1C.

As noted above, portable and wearable electronic devices can be designed to be used in many different environments and during any kind of activity throughout a user's day. For example, wearable electronic watches, headphones, and phones can be carried by a user during exercise, sleep, driving, biking, hiking, swimming, diving, outside in the rain, outside in the sun, and so forth. Wearable electronic devices described herein are configured to withstand the varied and often harsh conditions of various environments, including changing environments and wet environments. Wet environments can include wearing devices in the rain or when submerged during bathing, swimming, or diving, for example.

Examples of electronic devices disclosed herein include components, features, arrangements, and configurations that facilitate use under different environments. For example, electronic devices disclosed herein include components, features, arrangements, and configurations that maintain use of the device under water, such as while diving at depth below the water's surface. In some examples, electronic devices disclosed herein include button configurations that compensate for the hydrostatic pressure applied to the button, such as to limit undesired actuation of the button due to hydrostatic pressure.

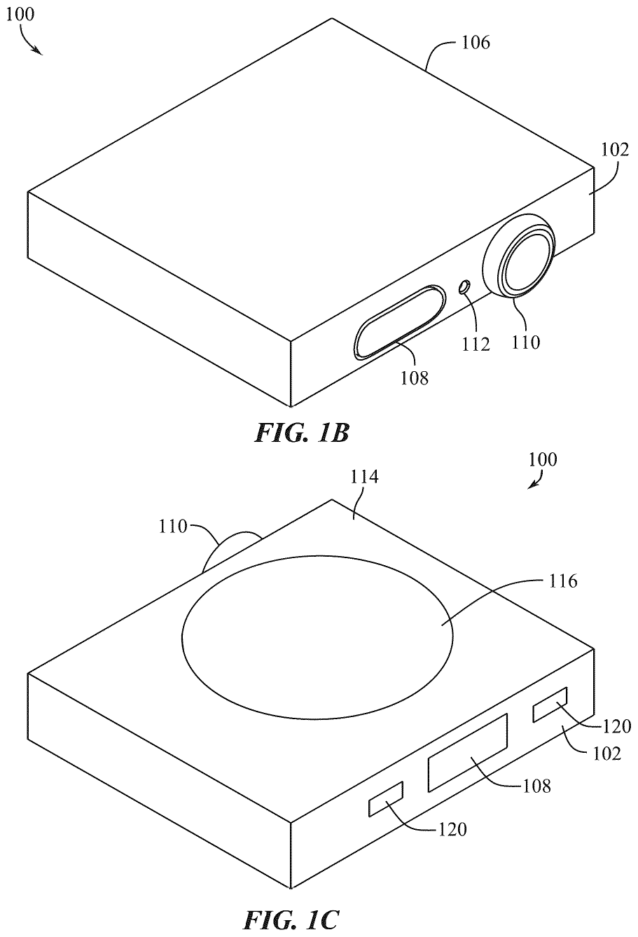

Along these lines, FIG. 2 shows a schematic view of a pressure compensating button or button assembly 202 (hereinafter “button” for sake of convenience). As described herein, the button 202 can limit undesired actuation from an external force or pressure. For example, the button 202 can include one or more features to limit actuation caused by hydrostatic pressure while diving or swimming at depth below the water's surface. In this manner, the button 202 can operate under varying environments and conditions. As a result, the button 202 can define or form at least a portion of a pressure compensation system.

To counter external pressure (e.g., hydrostatic pressure), the button 202 can include a compensating mechanism. The compensating mechanism can be passive to compensate for changing pressure applied to a pressure area of the button 202. For example, the compensating mechanism can passively compensate for surrounding pressure, such that the button 202 is usable at pressure, as described herein.

FIG. 2 shows the button 202 associated with electronic device 100, with the housing 102 of the electronic device 100 defining an internal volume 204. In such examples, an electronic component can be disposed in the internal volume 204. The electronic component can include a processor, a memory, or other electronics. In one example, the button 202 can include a depressible interface 206. In such examples, the depressible interface 206 can be depressed by a user to actuate the button 202. The depressible interface 206 can be exposed to the external environment, such as defining an external surface of the electronic device 100, although other configurations are contemplated. In one example, the button 202 can include a tactile switch 210. The tactile switch 210 can provide a haptic feedback to the user when pressure is applied to actuate the switch. For example, the tactile switch 210 can provide a tactile feedback, such as an audible and/or physical click when actuated. In one example, the tactile switch 210 can be a tactile dome switch. When pressed, the dome collapses to provide tactile feedback and complete an electrical circuit.

In one example, the button 202 can include a first pressure accumulator 216. At least a portion of the first pressure accumulator 216 can be exposed to the external environment to receive an external pressure. In one particular example, the first pressure accumulator 216 is configured to receive a first hydrostatic pressure. In such examples, the external pressure (e.g., first hydrostatic pressure) can provide a first force F₁ on the first pressure accumulator 216.

The first pressure accumulator 216 can be associated with the depressible interface 206. For example, the first pressure accumulator 216 can include a first piston or plunger 218 (hereinafter “first piston” for sake of convenience). The first piston 218 can be exposed at least partially to the external environment. In one example, the first piston 218, which can be referred to as a button piston, can extend from the depressible interface 206. The first piston 218 can extend through the housing 102 into the internal volume 204. In such examples, the first force F1 can bias the first piston 218 into the housing 102. The first force F1 can be based on the size of the first piston 218. For example, the first piston 218 can have a first size. In one example, the first piston 218 is cylindrical and the first size includes a first diameter of the first piston 218. In such examples, a larger sized (e.g., larger diameter) first piston 218 can result in a greater first force F1. Conversely, a smaller sized (e.g., smaller diameter) first piston 218 can result in a smaller first force F1. As shown, a first seal 220 can be disposed between the first piston 218 and the housing 102. In this manner, the first piston 218 can be movable through a first water tight seal isolating the external environment from the internal environment. Additionally, according to various embodiments, the first piston 218 and/or the second piston 226 can have any geometric cross-section, and the resulting force exerted by the first piston 218 and/or second piston 226 is commensurate with the cross-sectional area of the piston.

In one example, the button 202 can include a second pressure accumulator 224. At least a portion of the second pressure accumulator 224 can be exposed to the external environment to receive an external pressure. In one particular example, the second pressure accumulator 224 is configured to receive a second hydrostatic pressure. In such examples, the external pressure (e.g., second hydrostatic pressure) can provide a second force F2 on the second pressure accumulator 224.

The second pressure accumulator 224 can include a second piston or plunger 226 (hereinafter “second piston” for sake of convenience). The second piston 226 can be exposed at least partially to the external environment. In one example, the second piston 226, which can be referred to as a reference piston, can extend through the housing 102 into the internal volume 204. In such examples, the second force F2 can bias the second piston 226 into the housing 102. The second force F2 can be based on the size of the second piston 226. For example, the second piston 226 can have a second size. In one example, the second piston 226 is cylindrical and the second size includes a second diameter of the second piston 226. In such examples, a larger sized (e.g., larger diameter) second piston 226 can result in a greater second force F2. Conversely, a smaller sized (e.g., smaller diameter) second piston 226 can result in a smaller second force F2. Alternatively, the second piston 226 may have a non-cylindrical shape, such as a cylinder with an enlarged cap, that allows more or less of the hydrostatic pressure, depending on the shape, to influence the second force F2. As shown, a second seal 228 can be disposed between the second piston 226 and the housing. In this manner, the second piston 226 can be movable through a second water tight seal isolating the external environment from the internal environment. In one example, the tactile switch 210 can be isolated from the external environment via the first water tight seal and the second water tight seal, such as in a manner as shown in FIG. 2.

The second pressure accumulator 224 can reduce a force applied by the first pressure accumulator 216 on the tactile switch 210. For example, the second pressure accumulator 224 can counteract, at least partially, the first pressure accumulator 216 to limit an actuation of the tactile switch 210 via the first hydrostatic pressure. For example, the tactile switch 210 can be positioned such that a sufficient first force F₁ actuates the tactile switch 210. In such examples, increasing hydrostatic pressure on the first piston 218 can cause the first piston 218 to actuate the tactile switch 210. The second piston 226 can be positioned such that the second force F₂ reduces, counteracts or offsets at least a portion of the first force F₁. In such examples, the increasing hydrostatic pressure can increase the second force F₂ to counteract the increasing first force F₁ to limit undesired actuation of the tactile switch 210 due to increasing hydrostatic pressure.

The second pressure accumulator 224 can be coupled to the first pressure accumulator 216. In one example, the button 202 can include a mechanical linkage 230 used to compensate for increasing hydrostatic pressure. As shown, the mechanical linkage 230 can couple the second pressure accumulator 224 to the first pressure accumulator 216, such as the second piston 226 to the first piston 218. In such examples, the second hydrostatic pressure applied to the second piston 226 can reduce, counteract or offset the first hydrostatic pressure applied to the first piston 218, or vice-versa. In this and other manners, the mechanical linkage 230 can be configured such that the second hydrostatic pressure received by the second pressure accumulator 224 counteracts, at least partially, the first hydrostatic pressure received by the first pressure accumulator 216. The second pressure accumulator 224 counteracting, at least partially, the first hydrostatic pressure, can allow the button 202 to be used in environments with greater overall hydrostatic pressure, without undesired or unintentional button actuation. Although a mechanical linkage 230 is shown, the second pressure accumulator 224 can be coupled to the first pressure accumulator 216 in other ways. For example, the pressure accumulators 216, 224 can be coupled mechanically, hydraulically, or electronically (e.g., via a sensor), among other configurations, without intent to limit.

As shown, the button 202 can include a lever 234 and a fulcrum 236. The lever 234 and/or fulcrum 236 can be isolated from the external environment, such as disposed in the internal volume 204. As shown, the first piston 218 can extend from the depressible interface 206 and through the housing into the internal volume 204 to contact the lever 234 at a first contact point 238. In such examples, the first piston 218 can extend from the depressible interface 206 to exert the first force F₁ on the lever 234 (e.g., at the first contact point 238). Similarly, the second piston 226 can extend through the housing into the internal volume 204 to contact the lever 234 at a second contact point 240. The second piston 226 can be configured to exert the second force F₂ on the lever 234 (e.g., at the second contact point 240). As shown, the fulcrum 236 can be disposed between the first contact point 238 and the second contact point 240, with the lever 234 pivotable about the fulcrum 236.

The lever 234 can be configured to actuate the tactile switch 210. For example, pivotable movement of the lever 234 about the fulcrum 236 can apply a pressure against the tactile switch 210 to actuate the switch. In such examples, the tactile switch 210 can exert a third force F_{T} on the lever 234. The third force F_{T} can be exerted on the lever 234 at a third contact point 246. In the example illustrated in FIG. 2, the tactile switch 210 can be disposed between the fulcrum 236 and the second contact point 240. The tactile switch 210 can be configured to contact the lever 234 between the fulcrum 236 and the second contact point 240. In such examples, the tactile switch 210 can exert the third force F_{T} on the lever 234 between the fulcrum 236 and the second contact point 240. In this manner, the tactile switch 210 can act on the same side of the lever 234 as the second piston 226, although other configurations are contemplated. Such examples are non-limiting, and the tactile switch 210 can be positioned at other locations along the lever 234, on various sides of the fulcrum 236, and in various orientations.

In one example, the depressible interface 206 can exert a fourth force F_{button} (e.g., a button force) on the lever 234. The fourth force F_{button} can be the force applied by the user to actuate the button 202. As shown, the fourth force F_{button} can be exerted on the lever 234 via the first piston 218. In such examples, the fourth force F_{button} can be exerted on the lever 234 at the first contact point 238. As a result, the total forces acting on the lever 234 at the first contact point 238 can be a combination of the first force F₁ and the fourth force F_{button}.

Pivotable movement of the lever 234 about the fulcrum 236 to actuate the tactile switch 210 can be based on a force/moment balance about the fulcrum 236. For example, the first contact point 238 can be at a first distance D₁ from the fulcrum 236. The second contact point 240 can be at a second distance D₂ from the fulcrum 236. The third contact point 246 can be at a third distance D_{T} from the fulcrum 236. The first distance D₁ can be different than the second distance D₂. For example, the first distance D₁ can be less than the second distance D₂. The third distance D_{T} can be different than the first distance D₁ and/or the second distance D₂. For example, the third distance D_{T} can be less than the first distance D₁ and/or the second distance D₂. As shown, the first force F₁ can be parallel to the second force F₂. Similarly, the third force can be parallel to the first force F₁ and/or the second force F₂.

The force/moment balance about the fulcrum 236 can be represented using Equation 1 below:

$$( {F}_{button} + {F}_{1} ) {D}_{1} = {F}_{T} {D}_{T} + {F}_{2} {D}_{2} \qquad ( Equation 1 )$$

Solving for the third force F_{T}, the force acting against the tactile switch 210 can be represented using Equation 2 below:

$${F}_{T} = ( ( {F}_{button} + {F}_{1} ) {D}_{1} - {F}_{2} {D}_{2} ) / {D}_{T} \qquad ( Equation 2 )$$

The first and second pistons 218, 226 can be sized such that the force acting against the tactile switch 210 (e.g., third force F_{T}) is zero when there is no force acting on the depressible interface 206 (i.e., when the fourth force F_{button} is zero), even while the first and second pistons 218, 226 are influenced by hydrostatic pressure. For example, the second piston 226 can be sized relative to the first piston 218, such that the third force F_{T} is zero when the fourth force F_{button} is zero. In one example, the second diameter of the second piston 226 can be sized relative to the first diameter of the first piston 218, such that the third force F_{T} is zero when the fourth force F_{button} is zero.

In this manner, hydrostatic pressure (e.g., increasing hydrostatic pressure) can be mitigated, such as in a passive manner, to ensure operation of the button 202 under water. For example, undesired actuation of the button 202 due to hydrostatic pressure can be limited by the moment created by the second force F₂ canceling or offsetting the moment created by the first force F₁.

The specific features described with reference to FIG. 2 are for exemplary purposes only, and the button 202 can include other features and configurations. For example, the button 202 can include other components and arrangements that utilize offsetting forces to balance the hydrostatic forces acting on the button 202. As one example, hydrostatic pressure can be applied to opposing sides of the depressible interface 206, such that hydrostatic pressure does not bias the depressible interface 206 to move in any one direction.

Any of the features, components, and/or parts, including the arrangements and configurations thereof shown in FIG. 2 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 2.

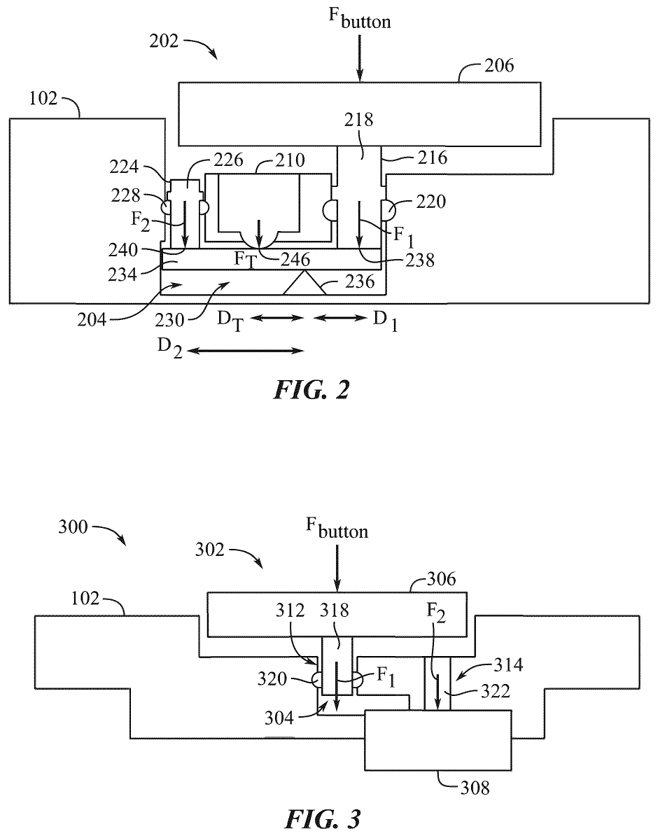

FIG. 3 shows a schematic view of another pressure compensation system 300. Rather than relying on physics or mechanical linkages, the pressure compensation system 300 illustrated in FIG. 3 can use one or more sensors or sensor systems to detect and/or compensate for hydrostatic pressure. For example, one or more sensors or systems can compensate for surrounding pressure, such that a button is usable at pressure, as described herein.

As shown, the pressure compensation system 300 can include a button or button assembly 302 (hereinafter “button” for sake of convenience). Like button 202, the button 302 can limit undesired actuation from an external force or pressure (e.g., hydrostatic pressure). The button 302 can be associated with electronic device 100, with the housing 102 of the electronic device 100 defining an internal volume 304. In one example, the button 302 can include a depressible interface 306. Like depressible interface 206, the depressible interface 306 can be depressed by a user to actuate the button 302. The depressible interface 306 can be exposed to the external environment, such as defining an external surface of the electronic device 100, although other configurations are contemplated. In one example, the button 302 can include a differential pressure sensor 308, for the purposes detailed herein.

In one example, the housing 102 can define multiple apertures, such as a piston port or aperture 312 and a reference port or aperture 314. In such examples, the button 302 can include a plunger or piston 318 extending through the piston aperture 312 into the internal volume 304. At least a portion of the piston 318 can be exposed to the external environment. In such examples, external pressure (e.g., hydrostatic pressure) can provide a first force F₁ on the piston 318.

The piston 318 can extend from the depressible interface 306. In one example, the piston 318 can be movable through the piston aperture 312 to change a size of the internal volume 304. For example, a greater portion of the piston 318 can be positioned in the internal volume 304, thereby decreasing the size of the internal volume 304. Conversely, decreasing the size of the portion positioned in the internal volume 304 can increase the size of the internal volume 304. In such examples, the first force F₁ can bias the piston 318 into the housing 102. The first force F₁ can be based on the size of the piston 318. For example, the piston 318 can be cylindrical having a diameter. In such examples, a larger diameter can result in a greater first force F₁. Conversely, a smaller diameter can result in a smaller first force F₁.

As shown, a seal 320 can be disposed between the piston 318 and the housing 102. In this manner, the internal volume 304 can be isolated from the external environment and defined between the seal and the differential pressure sensor 308. In such examples, the internal volume 304 can have a first pressure P1. The first pressure P1, which can be a sensed pressure, can vary based on a position of the piston 318 in the internal volume 304. For example, movement of the piston 318 into the internal volume 304 can increase the first pressure P1. Conversely, decreasing the size of the piston 318 within the internal volume 304 can decrease the first pressure P1.

In one example, the pressure compensation system 300 can include a gel 322 disposed in the reference aperture 314. The gel 322 can extend in the reference aperture 314 from the differential pressure sensor 308 to the external environment. The gel 322 can be a silicone gel or another similar material. Such examples are illustrative only, and the reference aperture 314 can be filled with other materials or components, such as a sealed piston or plunger in one example. External pressure (e.g., hydrostatic pressure) can provide a second force F₂ on the gel 322 or other component in the reference aperture 314. In such examples, the second force F₂ can cause the reference aperture 314 to have a second pressure P₂, which can be a reference pressure.

The differential pressure sensor 308 can be configured to measure the sensed and reference pressures. For example, the differential pressure sensor 308 can measure the first pressure P₁ within the internal volume 304, and the second pressure P₂ of the reference aperture 314. In this manner, the differential pressure sensor 308 can be exposed to two different mediums, such as the external environment and a trapped medium within the internal volume 304.

The differential pressure sensor 308 can be activated when the first pressure P₁ exceeds a minimum pressure. For example, the differential pressure sensor 308 can be activated when the first pressure P₁ is greater than the second pressure P₂ plus a threshold (see Equation 3 below). In such examples, the threshold can be predetermined based on one or more characteristics of the pressure compensation system 300, the electronic device 100, or the environment.

$${P}_{1} > ( {P}_{2} + Threshold ) \qquad ( Equation 3 )$$

Increasing the first pressure P₁ relative to the second pressure P₂ can be caused by a third force F_{button} (e.g., a button force) exerted on the depressible interface 306. The third force F_{button} can be the force applied by the user to actuate the button 302. The third force F_{button} can be applied to the piston 318 to move the piston 318 through the piston aperture 312 and into the internal volume 304.

In one example, the diameter of the piston 318 can be equal to or substantially equal to the diameter of the reference aperture 314. In such examples, the first pressure P₁ can be equal to or substantially equal to the second pressure P₂ when there is no force acting on the depressible interface 306 (i.e., when the third force F_{button} is zero), even while the first and second pressures P₁, P₂ change due to varying hydrostatic pressure.

In some examples, the pressure compensation system 300 can include other features. For example, the button 302 can include a haptic engine or component(s) to provide a desired tactile feedback, such as an audible and/or physical click when the button 302 is actuated. In some examples, the pressure compensation system 300 can utilize sensor input from other sensors of the electronic device 100. For example, the pressure compensation system 300 can utilize sensor input from a depth sensor, a touch sensor, a speaker, etc. to determine when to activate the differential pressure sensor 308, such as to determine the threshold of Equation 3 above. In some examples, the pressure compensation system 300 can include one or more compensating bridges extending through the housing 102 to balance the first and second pressures P₁, P₂.

Any of the features, components, and/or parts, including the arrangements and configurations thereof shown in FIG. 3 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 3.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. An electronic device comprising:
a housing defining an internal volume; and
a button assembly comprising:
a depressible interface defining an external surface of the electronic device;
a tactile switch;
a first pressure accumulator associated with the depressible interface and configured to receive a first hydrostatic pressure; and
a second pressure accumulator coupled to the first pressure accumulator and configured to receive a second hydrostatic pressure.

2. The electronic device of claim 1, wherein the button assembly comprises a mechanical linkage coupling the second pressure accumulator to the first pressure accumulator, wherein the second pressure accumulator reduces a force applied by the first pressure accumulator on the tactile switch.

3. The electronic device of claim 1, wherein the button assembly comprises:
a lever disposed in the internal volume;
the first pressure accumulator comprising a first piston extending from the depressible interface and through the housing into the internal volume to contact the lever at a first contact point;
the second pressure accumulator comprising a second piston extending through the housing into the internal volume to contact the lever at a second contact point; and
a fulcrum disposed between the first contact point and the second contact point, the lever pivotable about the fulcrum.

4. The electronic device of claim 3, wherein the tactile switch is configured to contact the lever between the fulcrum and the second contact point.

5. The electronic device of claim 3, further comprising:
a first seal disposed between the first piston and the housing; and
a second seal disposed between the second piston and the housing.

6. The electronic device of claim 3, wherein:
the first contact point is at a first distance from the fulcrum;
the second contact point is at a second distance from the fulcrum; and
the first distance is less than the second distance.

7. The electronic device of claim 3, wherein:
the first piston exerts a first force on the lever;
the second piston exerts a second force on the lever;
the tactile switch exerts a third force on the lever; and
the depressible interface exerts a fourth force on the lever.

8. The electronic device of claim 7, wherein:
the first piston includes a first diameter;
the second piston includes a second diameter; and
the second diameter is sized relative to the first diameter such that the third force is zero when the fourth force is zero.

9. A button assembly comprising:
a depressible interface exposed to an external environment;
a lever isolated from the external environment, the lever including a fulcrum;
a first piston having a first size, the first piston exposed to the external environment and extending from the depressible interface to exert a first force on the lever at a first contact point;
a second piston having a second size, the second piston exposed to the external environment and configured to exert a second force on the lever at a second contact point, the second force configured to reduce the first force; and
a tactile switch.

10. The button assembly of claim 9, wherein the fulcrum is disposed between the first contact point and the second contact point.

11. The button assembly of claim 9, wherein:
the tactile switch is configured to exert a third force on the lever;
the depressible interface is configured to exert a fourth force on the lever; and
the second piston is sized relative to the first piston such that the third force is zero when the fourth force is zero.

12. The button assembly of claim 11, wherein:
the first piston is cylindrical and the first size includes a first diameter of the first piston;
the second piston is cylindrical and the second size includes a second diameter of the second piston; and
the second diameter is sized relative to the first diameter such that the third force is zero when the fourth force is zero.

13. The button assembly of claim 9, wherein:
the first piston is movable through a first water tight seal isolating the external environment from an internal environment; and
the second piston is movable through a second water tight seal isolating the external environment from the internal environment.

14. The button assembly of claim 13, wherein the tactile switch is isolated from the external environment via the first water tight seal and the second water tight seal.

15. A pressure compensation system for an electronic device, comprising:
a housing defining:
an internal volume;
a piston aperture; and
a reference aperture;
a button assembly comprising a piston extending through the piston aperture into the internal volume; and
a differential pressure sensor configured to measure:
a first pressure within the internal volume; and
a second pressure of the reference aperture.

16. The pressure compensation system of claim 15, wherein:
the pressure compensation system further comprises a seal disposed between the piston and the housing; and
the internal volume is isolated from an external environment and defined between the seal and the differential pressure sensor.

17. The pressure compensation system of claim 16, further comprising a gel disposed in the reference aperture.

18. The pressure compensation system of claim 17, wherein the piston is exposed to the external environment.

19. The pressure compensation system of claim 16, wherein:
the button assembly further comprises a depressible interface exposed to the external environment and defining an external surface of the electronic device; and
the piston extends from the depressible interface and is movable through the piston aperture to change a size of the internal volume.

20. The pressure compensation system of claim 15, wherein the piston has a diameter substantially equal to the diameter of the reference aperture.
